(19) United States
(12) Patent Application Publication
(10) Pub. No.: US 2023/0274210 A1
(43) Pub. Date: Aug. 31, 2023

(54) METHODS AND APPARATUS FOR AUTOMATIC ITEM LOCATION ASSIGNMENT

(71) Applicant: Walmart Apollo, LLC, Bentonville, AR (US)

(72) Inventors: Apoorva Modali, Chandler, AZ (US); Deep Narayan Mishra, Sunnyvale, CA (US); Xueqi He, Santa Clara, CA (US)

(21) Appl. No.: 17/587,017

(22) Filed: Jan. 28, 2022

(51) Int. Cl. G06Q 10/06; G06F 30/13

(52) U.S. Cl. CPC G06Q 10/06315; G06F 30/13; G06F 2111/04

(57) ABSTRACT

This application relates to automated processes for assigning item categories to fixtures of a floorplan. For example, a computing device may obtain layout data for a retail location. The layout data may identify and characterize a location of fixtures, such as shelving, end caps, and aisles, within the retail location. The computing device also determines a plurality of placement options for each of a plurality of categories based on applying at least one constraint criteria to the layout data. Further, the computing device determines one of the plurality of placement options for each of the plurality of categories based on applying objective criteria to the plurality of placement options for the plurality of categories. The computing device also generates assignment data assigning each of the plurality of categories to the corresponding one of the plurality of categories. Further, the computing device stores the assignment data in a data repository.

### TECHNICAL FIELD

The disclosure relates generally to retail layout organization and, more specifically, to automatic processes to categorically assign locations within retail locations for item placement.

### BACKGROUND

Retailers typically must determine where to place items within retail locations, such as within a store. For example, a retailer may draw a floorplan that illustrates various departments within a store, as well as fixtures, such as storage units and shelving, assigned to each department. To generate a floorplan, retailers may spend significant amounts of time and money. For example, there are drawing costs associated with generating the floorplan, as well as input needed from various employees to determine how to allocate the various departments within the store and which storage units to use in each department to hold merchandise. In some examples, retailers may want to reorganize a layout to accommodate, for example, additional departments or make room for an expansion of a department. These reorganizations take additional time and efforts, and often involve additional planning to reduce disturbance to shoppers. As such, there are opportunities to address issues with retail layout organization and item assignment.

### SUMMARY

The embodiments described herein are directed to the automated processes for the assignment of categories (e.g., item categories) to fixtures of a floorplan. Specifically, the embodiments employ models to determine a preferred placement of categories within a department floorplan. Among various advantages, the embodiments may minimize the movement of items when displacing categories of a current placement, thereby reducing labor costs to move items. The embodiments may also maximize adjacency such as keeping two or more categories near each other so as to drive each other’s sales. Further, the embodiments may increase proximity preferences, such as placing particular categories in certain locations to increase visibility. The embodiments may also maximize shop view, where categories that belong to a same shop are placed near each other to increase customer visibility. A “shop” may include multiple related categories, for example. For example, a “Sports” shop may include a group of categories including “Lacrosse,” “Golf,” “Baseball,” “Swimming,” “Team Sports,” “Goals,” and “Rackets Sports,” and may be located in a Sporting Goods department of a retail location. The embodiments may further maximize shop flow to increase the shopping experience. Persons of ordinary skill in the art would recognize additional advantages as well.

In accordance with various embodiments, exemplary systems may be implemented in any suitable hardware or hardware and software combination, such as in one or more suitable computing devices. For example, in some embodiments, a computing device (e.g., server) comprising at least one processor obtains layout data for a retail location (e.g., store). The layout data may identify and characterize a location of fixtures, such as shelving, end caps, and aisles, within the retail location. The computing device also determines a plurality of placement options for each of a plurality of categories based on applying at least one constraint criteria to the layout data. Further, the computing device determines one of the plurality of placement options for each of the plurality of categories based on applying objective criteria to the plurality of placement options for the plurality of categories. The computing device also generates assignment data assigning each of the plurality of categories to the corresponding one of the plurality of categories. Further, the computing device stores the assignment data in a data repository.

In some embodiments, a method by at least one processor includes obtaining layout data for a retail location (e.g., store). The layout data may identify and characterize a location of fixtures, such as shelving, end caps, and aisles, within the retail location. The method also includes determining a plurality of placement options for each of a plurality of categories based on applying at least one constraint criteria to the layout data. Further, the method includes determining one of the plurality of placement options for each of the plurality of categories based on applying objective criteria to the plurality of placement options for the plurality of categories. The method also includes generating assignment data assigning each of the plurality of categories to the corresponding one of the plurality of categories. Further, the method includes storing the assignment data in a data repository.

In some embodiments, a non-transitory computer readable medium has instructions stored thereon. The instructions, when executed by at least one processor, cause a device to perform operations that include includes obtaining layout data for a retail location (e.g., store). The layout data may identify and characterize a location of fixtures, such as shelving, end caps, and aisles, within the retail location. The operations also include determining a plurality of placement options for each of a plurality of categories based on applying at least one constraint criteria to the layout data. Further, the operations include determining one of the plurality of placement options for each of the plurality of categories based on applying objective criteria to the plurality of placement options for the plurality of categories. The operations also include generating assignment data assigning each of the plurality of categories to the corresponding one of the plurality of categories. Further, the operations include storing the assignment data in a data repository.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 is a block diagram of a category assignment system in accordance with some embodiments;

FIG. 2 is a block diagram of an exemplary category assignment computing device in accordance with some embodiments;

FIGS. 3 and 4 are block diagrams illustrating examples of various portions of the category assignment system of FIG. 1 in accordance with some embodiments;

FIGS. 5 and 6A illustrate retail location layouts in accordance with some embodiments;

FIG. 6B illustrates a graph representation of the retail location layout of FIG. 6A in accordance with some embodiments;

FIGS. 7A and 7B illustrate changes to a retail location layout in accordance with some embodiments;

FIG. 8 illustrates a retail location layout in accordance with some embodiments;

FIG. 9 is a flowchart of an example method that can be carried out by the category assignment system 100 of FIG. 1 in accordance with some embodiments; and

FIG. 10 is a flowchart of another example method that can be carried out by the category assignment system 100 of FIG. 1 in accordance with some embodiments.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.”

The embodiments employ a framework to allocate item categories to fixtures within a floorplan and, in some examples, to shops within the floorplan. Item categories may include, for example, “bikes,” “family,” “boys,” girls,” “preschool,” “electronics,” “produce,” “meats,” “toys,” or any other suitable item category. A “shop” may include two or more related categories. For example, a shop of “automobile” may include categories of “oils,” “brake fluids,” “cleaners,” and “parts.” The framework includes consideration of constraint criteria as well as objective criteria to determine the allocation. The framework may apply the constraint criteria to a plurality of placement options to determine a subset of placement options. As described herein, the constraint criteria may include one or more models that characterize, for example, single section assignments (e.g., assuring a category is assigned to a single section rather than multiple sections), single category assignments (e.g., assuring a fixture is assigned to a single category), adjacency relationships (e.g., constraints as to which categories may be near each other), adjacency hard constraints, restricted adjacency constraints, weak connectivity constraints (e.g., assuring at least a number of neighboring fixtures belong to a same shop), strong connectivity constraints (e.g., assuring a shop’s fixtures are all connected), and flow constraints, among others.

Further, the framework may apply one or more models to the subset of placement options to generate scores, and may select one of the subset of placement options based on the generated scores. For example, the one or more models may be executed in iterations, where each iteration adds one or more selective strong connectivity constraints to improve shop connectivity. Each iteration may produce a score based on its category assignments and the solution with the best score may be selected to be the final solution. The one or more models characterize objective criteria such as, for example, objectives to minimize movement, maximize adjacency, maximize shop flow, maximize preferred wrapping, maximize preferred fixture types, maximize preferred area types, and maximize category proximity, among others. In some examples, the models include an objective function with components that are minimized, or maximized, and whose outputs are weighted to generate a final score. In some examples a user may preconfigure the weights so as to give higher, or lower, priority to various objectives.

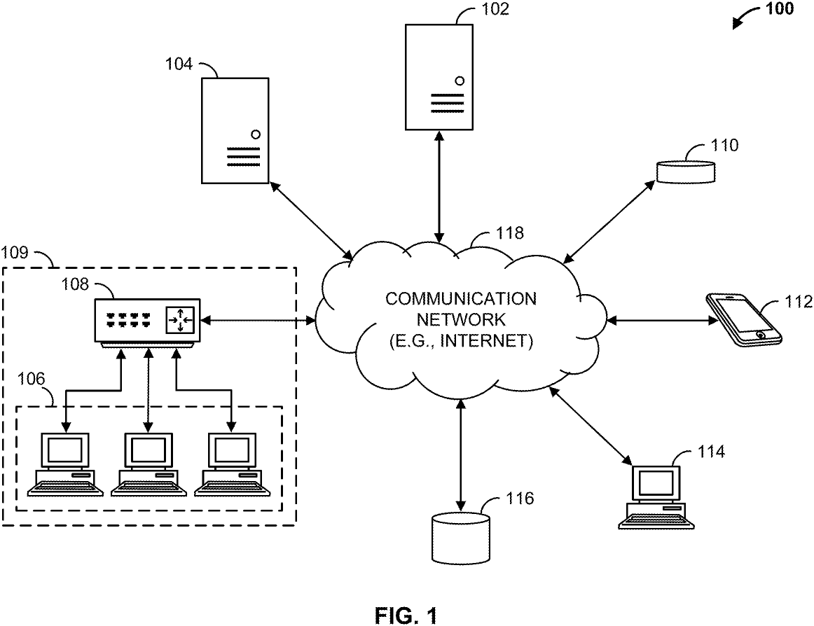

Turning to the drawings, FIG. 1 illustrates a block diagram of a category assignment system 100 that includes category assignment computing device 102 (e.g., a server, such as an application server), web server 104, workstation(s) 106, database 116, and multiple associate computing devices 110, 112, 114 operatively coupled over network 118. Category assignment computing device 102, workstation(s) 106, web server 104, third-party server 120, and multiple associate computing devices 110, 112, 114 can each be any suitable computing device that includes any hardware or hardware and software combination for processing data. For example, each of category assignment computing device 102, web server 104, workstations 106, and multiple associate computing devices 110, 112, 114 can include one or more processors (e.g., each processor including one or more processing cores), one or more field-programmable gate arrays (FPGAs), one or more application-specific integrated circuits (ASICs), one or more state machines, digital circuitry, or any other suitable circuitry. In addition, each can transmit data to, and receive data from, communication network 118.

In some examples, each of category assignment computing device 102 can be a computer, a workstation, a laptop, a server such as a cloud-based server, a distributed computing system, or one or more of any other suitable device. Each of multiple associate computing devices 110, 112, 114 can be a mobile device such as a cellular phone, a laptop, a computer, a table, a personal assistant device, a voice assistant device, a digital assistant, or any other suitable device.

Associate computing devices 110, 112, 114 may be operated by employees of store 109, for example. Each of associate computing devices 110, 112, 114 may be in communication with workstation 106. Although FIG. 1 illustrates three associate computing devices 110, 112, 114, category assignment system 100 can include any number of associate computing devices 110, 112, 114. Similarly, category assignment system 100 can include any number of workstation(s) 106, category assignment computing devices 102, third-party servers 120, web servers 104, and databases 116.

Workstation(s) 106 are operably coupled to communication network 118 via router (or switch) 108. Workstation(s) 106 and/or router 108 may be located at a store 109, for example. In some examples, workstation 106 is a register at store 109. Workstation(s) 106 can communicate with category assignment computing device 102 over communication network 118. The workstation(s) 106 may send data to, and receive data from, category assignment computing device 102. For example, the workstation(s) 106 may transmit data related to a layout of a store, such as store 109, to category assignment computing device 102. Workstation(s) 106 may also communicate with web server 104. For example, web server 104 may host one or more web pages, such as a retailer’s website. Workstation(s) 106 may be operable to transmit the layout of a store to web server 104 through, for example, an Application Programming Interface (API). Web server 104 may display the layout of the store on the retailer’s website.

Database 116 can be a remote storage device, such as a cloud-based server, a memory device on another application server, a networked computer, or any other suitable remote storage. Category assignment computing device 102 is operable to communicate with database 116 over communication network 118. For example, category assignment computing device 102 can store data to, and read data from, database 116. For instance, category assignment computing device 102 may store layout assignment data within database 116. Layout assignment data may characterize an assignment of categories to fixtures within a store, such as store 109. Although shown remote to category assignment computing device 102, in some examples, database 116 can be a local storage device, such as a hard drive, a non-volatile memory, or a USB stick.

Communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. Communication network 118 can provide access to, for example, the Internet.

First associate computing device 110, second associate computing device 112, and N^{th} associate computing device 114 may communicate with category assignment computing device 102 and workstation 106 over communication network 118. For example, category assignment computing device 102 may transmit layout assignment data to one or more of first associate computing device 110, second associate computing device 112, and N^{th} associate computing device 114, which may cause the receiving associate computing device 110, 112, 114 to display a layout of a store in accordance with the layout assignment data.

### Assigning Item Categories to Fixtures of a Store Layout

As described herein, category assignment computing device 102 may perform operations to assign item categories to fixtures of a store layout. For example, category assignment computing device 102 may obtain layout data that identifies and characterizes a layout of a retail location. For example, the layout data may identify and characterize a location of fixtures, such as shelving, end caps, and aisles, within the retail location. The layout data may be for a layout of store 109 and stored in database 116, for example. Each fixture be one of a plurality of fixture types. The layout data may further identify, for each fixture, one or more of a fixture type, an orientation, whether a fixture rotates, and a dimension (e.g., x, y, z dimensions) and/or a shape (e.g., square shelving). The layout data may also identify, at least for some fixture types, a number of sections for each fixture. The layout data may further identify one or more shops, and categories belonging to each identified shop.

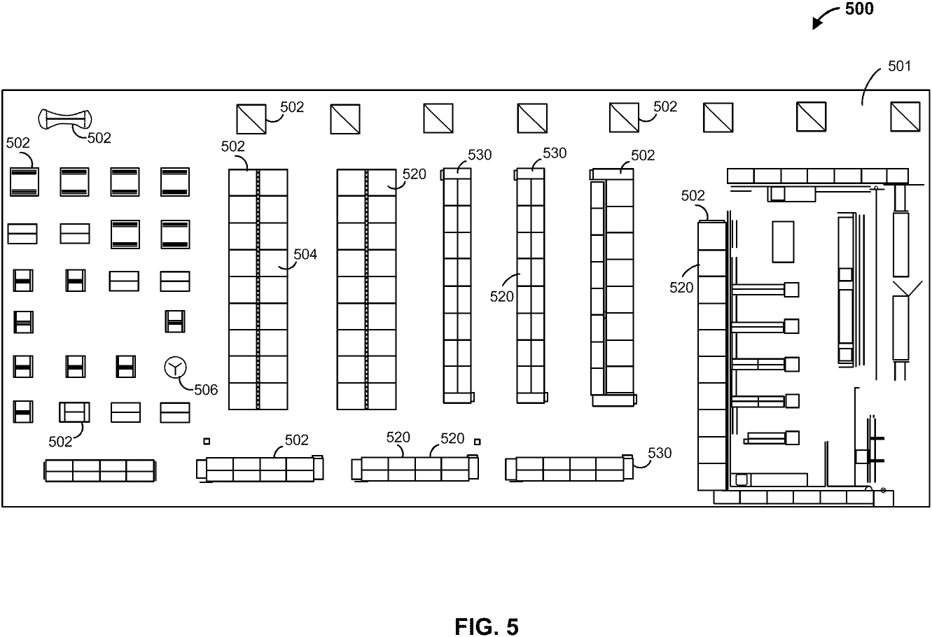

For example, FIG. 5 illustrates a layout 500 of a retail location 501 that includes various fixtures 502. Each fixture 502 may be one of a plurality of fixture types, such as shelving 504 and rotating fixture 506. At least some fixture types may include one or more sections 520, and at least some fixture types may include one or more end caps 530. Layout 500 further identifies aisles 540 and shops 550, 552.

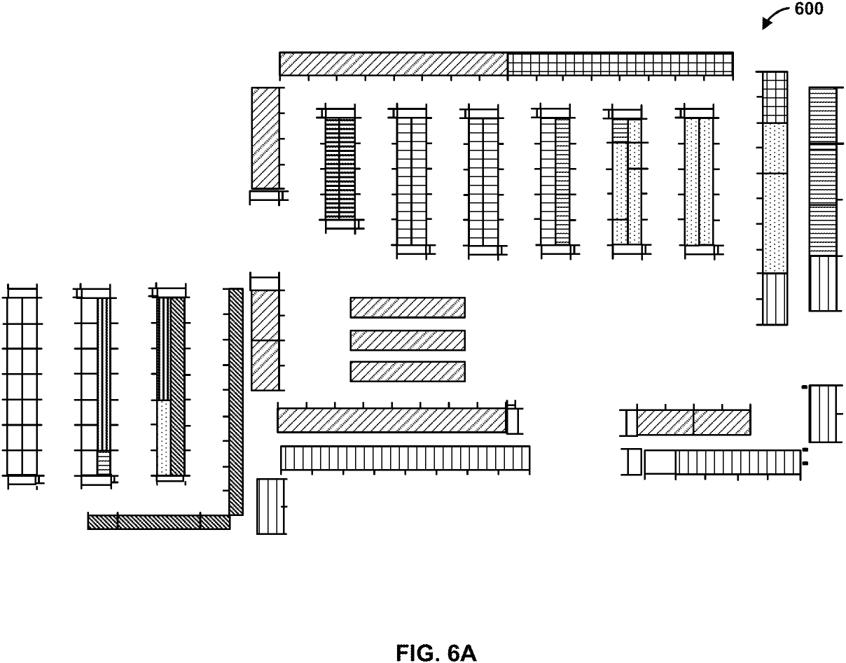

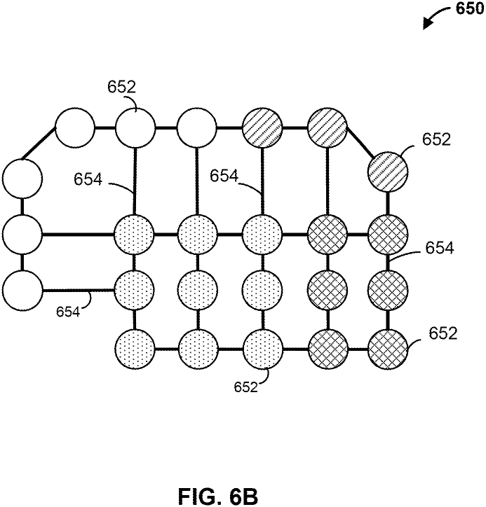

In some examples, the layout data includes a graph representation of fixtures and their connectivity. For example, FIG. 6A illustrates a layout 600 when each type of hashing represents a shop. Category assignment computing device 102 may generate graph data representing fixtures of the layout 600 and their corresponding connectivity, by assigning nodes to fixtures and edges as connections. As an example, FIG. 6B illustrates a graph 650 generated based on layout 600. Graph 650 includes nodes 652 that represent fixtures and are hashed in a same fashion when belonging to a same shop. Edges 654 connect the nodes 652 in accordance with the layout 600. Thus, for example, nodes 652 connected by an edge 654 represent adjacent fixtures. As described herein, category assignment computing device 102 may apply constraint criteria to the graph data to determine a plurality of placement options. Category assignment computing device 102 may further apply objective criteria to the graph data and the plurality of placement options to generate assignment data, as also described herein.

Referring back to FIG. 1, category assignment computing device 102 may determine a plurality of placement options for one or more categories defined by the layout data based on applying at least one constraint criteria to at least portions of the layout data. Each placement option assigns a corresponding category to one or more fixtures as defined by the layout data, for example. Further, constraint criteria may include one or more constraints that, in some examples, may be configured by a user (e.g., via workstation 106 or any of associate computing devices 110, 112, 114). For example, the constraint criteria may characterize a modeling of one or more constraints, such as single section assignments, single category assignments, adjacency relationships, adjacency hard constraints, restricted adjacency constraints, weak connectivity constraints, strong connectivity constraints, and flow constraints. For instance, the models may include any of the following:
Single Section Assignment Constraint ->
$${\sum }_{p ∈ {P}_{i}} {x}_{i p} = 1 , ∀ i ∈ C$$
Single Category Assignment Constraint ->
$${\sum }_{i ∈ C} {\sum }_{p ∈ {P}_{i k}} {x}_{i p} \leq 1 , ∀ k ∈ K$$
Adjacency Relationship Constraints -> y_{(ip),(jq)} ≤ xᵢₚ, ∀(i,j) ∈ A and (p, q) ∈ APᵢⱼ
Y(ᵢₚ),(_{jq}) ≤ x_{jq}, ∀(i,j) E A and (p, q) ∈ APᵢⱼ y_{(ip),(jq)} ≥ xᵢₚ, + x_{jq} - 1, ∀(i,j) ∈ A and (q, p) ∈ APᵢⱼ Adjacency Hard Constraint ->
$${\sum }_{\left(q , p\right) ∈ A {\text{P}}_{i j}} {y}_{\left(i p\right) , \left(j q\right)} = 1$$
Restricted Adjacency Constraint -> y_{(ip),(jq)} = 0
Weak Connectivity Constraint ->
$${\sum }_{{\text{k}}^{′} ∈ {\text{N}}_{\text{k}}} {z}_{{k}^{′}}^{s} + {ρ}_{k}^{s} \geq 2 ∗ {z}_{k}^{s} , ∀ k ∈ K , s ∈ S$$
Relationship Constraint ->
$${\sum }_{i ∈ {∪}_{s}} {\sum }_{p ∈ {P}_{i k}} {x}_{i p} = {z}_{k}^{s} , ∀ k ∈ K , ∈ S$$
Shop Flow Bound Constraint -> UBₛ₁ ≤ LBₛ₂ + buf fer, ∀ (s1,s2) ∈ SF
Strong Connectivity Constraints ->
$${\sum }_{k ∈ {T}_{1}} {Z}_{k}^{s} \leq \left|{T}_{1}\right| {α}_{{T}_{1}}^{s}$$
$$\begin{matrix}{\sum }_{k ε {V}_{1}} {Z}_{k}^{s} \leq \vert {V}_{1} \vert {α}_{{V}_{1}}^{s} \\ {\sum }_{k ε {\overline{T}}_{1}} {Z}_{k}^{s} \geq {α}_{{T}_{1}}^{s} + {α}_{{V}_{1}}^{s} - 1 \\ {\sum }_{k ε {T}_{2}} {Z}_{k}^{s} \leq \vert {T}_{2} \vert {α}_{{V}_{2}}^{s} \\ {\sum }_{k ε {V}_{2}} {Z}_{k}^{s} \leq \vert {V}_{2} \vert {α}_{{V}_{2}}^{s} \\ {\sum }_{k ε {\overline{T}}_{2}} {Z}_{k}^{s} \geq {α}_{{T}_{1}}^{s} + {α}_{{V}_{2}}^{s} - 1\end{matrix} \qquad \text{(collectively eqs. 1)}$$
where:
xᵢₚ future placement of category i with option p (p can be any placement option in a list of place options generated for category i, based on its requirements)

$${y}_{( i p ) , ( j , q )}$$
place category i and j with adjacent options p and q

$${Z}_{k}^{s}$$
binary variable. 1 if fixture section k is assigned to shop s

$${ρ}_{k}^{s}$$
binary variable. Buffer for weak connectivity constraint

$${α}_{T}^{s}$$
binary variable. 1 if there is at least one section in T is assigned to shop s
C set of categories in new layout
i, j index of category, i ∈ C, j ∈ C
K set of fixture sections
k, k′ index of fixture section, k ∈ K, k′ ∈ K
Pᵢ set of placement options generated for category i
Pᵢₖ set of placement options generated for category i and occupying fixture section k
p, q index of placement option, p ∈ Pᵢ, q ∈ Pⱼ
mᵢₚ # of movement of option p from i’s current placement
A set of category pairs with adjacency requirement
APᵢⱼ set of adjacent options of category i and j
dᵢₚ distance metric to specific proximity landmark
d^{S}ᵢₚ distance metric to specific proximity landmark when i is in shop s—
wᵢₚ wrap preference multiplier of i for placement option p
ƒᵢₚ fixture preference multiplier of i for placement option p
aᵢₚ area preference multiplier of i for placement option p
S set of shops
s index of shop, s ∈ S
Uₛ set of categories in shop s. If i ∈ Uₛ and j ∈ Uₛ, category i and j belongs to the same shop
Nₖ set of sections connected with section k
T subset of K. T ⊆ K
T̅ set of fixtures which is not in T but connect to a fixture in T. “Connect to” could be neighbor bridge, opposite, back to, or perpendicular to.

As such, category assignment computing device 102 may determine one or more placement options that assign each category to one or more fixtures (or fixture sections) and that satisfy one or more of the above noted constraint criteria. For example, and assuming that a single section assignment constraint is being enforced, category assignment computing device 102 may determine placement options for a category (e.g., with a particular option) where the category is assigned to a single fixture section. In other words, placement options where the category is distributed to more than one section are not considered (e.g., discarded), and are not part of the one or more placement options that are assigned to the category. As another example, constraint criteria that In some examples, category assignment computing device 102 execute a high performance solver (e.g., CPLEX solver) to determine the plurality of placement options based on the constraint criteria.

Further, category assignment computing device 102 applies objective criteria to each of the determined plurality of placement options for each category to determine one of the plurality of placement options for each category. The objective criteria may include one or more objective functions that operate on the layout data (e.g., the graph data) and the plurality of placement options to generate output data identifying one of the plurality of placement options for each category. In some examples, the one of the plurality of placement options for each category is determined by applying objective criteria that is based on a current (e.g., as defined by the layout data), and future (e.g., proposed), placement for a category. In some examples, the one of the plurality of placement options for each category is determined by applying objective criteria that is based on a pair of categories with an adjacency requirement. In some examples, the one of the plurality of placement options for each category is determined by applying objective criteria that is based on a distance from a proposed placement for the category to a location within the retail location. In some examples, the one of the plurality of placement options for each category is determined by applying objective criteria that is based on wrap preferences for each category (e.g., sections assigned to a category should be with a same aisle such that once an end of the aisle is reached, the category continues across the aisle).

In some examples, applying the objective criteria to each of the determined plurality of placement options comprises determining one or more of: a minimized movement, a maximized adjacency, a maximized shop flow, a maximized preferred wrapping, a maximized preferred fixture types, a maximized preferred area types, and a maximized category proximity. In some examples, category assignment computing device 102 applies a corresponding weight (e.g., as configured by a user) to a value characterizing a minimized movement, a value characterizing a maximized adjacency, a value characterizing a maximized shop flow, a value characterizing a maximized preferred wrapping, a value characterizing a maximized preferred fixture types, a value characterizing a maximized preferred area types, and a value characterizing a maximized category proximity. For instance, an exemplary objective function may include various weighted expressions, such as the following:

$$\begin{matrix}{w}_{1} ∗ \sum {}_{i ε c a t e g o r i e s} \sum {}_{p ε o p t i o n {s}_{i}} {m}_{i p} {x}_{i p} \\ - {w}_{2} ∗ \sum {}_{( i , \text{j} ) ε A} \sum {}_{( p , q ) ε A {P}_{i j}} {y}_{( i p ) , ( j , q )} \\ + {w}_{3} ∗ \sum {}_{i ε c a t e g o r i e s} \sum {}_{p ε o p t i o n {s}_{i}} {d}^{s} {}_{i p} {x}_{i p} \\ + {w}_{4} ∗ \sum {}_{i ε c a t e g o r i e s} \sum {}_{p ε o p t i o n {s}_{i}} {w}_{i p} {x}_{i p} \\ + {w}_{5} ∗ \sum {}_{i ε c a t e g o r i e s} \sum {}_{p ε o p t i o n {s}_{i}} {f}_{i p} {x}_{i p} \\ + {w}_{6} ∗ \sum {}_{i ε c a t e g o r i e s} \sum {}_{p ε o p t i o n {s}_{i}} {a}_{i p} {x}_{i p} \\ + {w}_{7} ∗ \sum {}_{i ε c a t e g o r i e s} \sum {}_{p ε o p t i o n {s}_{i}} {d}_{i p} {x}_{i p}\end{matrix} \qquad \text{(eq. 2)}$$

where:
xᵢₚ future placement of category i with option p
Y(ᵢₚ),(_{j,q}) place category i and j with adjacent options p and q
C set of categories in new layout
i, j index of category, i ∈ C, j ∈ C
K set of fixture sections
k, k′ index of fixture section, k ∈ K, k′ ∈ K
Pᵢ set of placement options generated for category i
Pᵢₖ set of placement options generated for category i and occupying fixture section k
p, q index of placement option, p ∈ Pᵢ, q ∈ Pⱼ
mᵢₚ # of movement of option p from i’s current placement
A set of category pairs with adjacency requirement
APᵢⱼ set of adjacent options of category i and j
dᵢₚ distance metric to specific proximity landmark
d^{S}ᵢₚ distance metric to specific proximity landmark when i is in shop s
wᵢₚ wrap preference multiplier of i for placement option p
ƒᵢₚ fixture preference multiplier of i for placement option p
aᵢₚ area preference multiplier of i for placement option p

In the above objective function of eq. 2, the first expression minimizes movement. As an example, to determine a movement for the objective function expression to minimize movement from a current location to a new location, category assignment computing device 102 may determine a distance (e.g., mᵢₚ) from a current node of the graph data for a category to a proposed node for the category (e.g., distance of 1 node, two nodes, three nodes, etc., counted based on edges to get from the current node to the proposed node). Further, the second expression maximizes adjacency, the third expression maximizes shop flow, and the fourth expression maximizes preferred wrapping. Further, the fifth expression maximizes preferred fixture types, the sixth expression maximizes preferred area types (e.g., a preferred area of the retail location), and the seventh expression maximizes category proximity.

Category assignment computing device 102 may solve the objective function (e.g., eq. 2) using a high performance solver of objective functions. For example, category assignment computing device 102 may execute the high performance solver (e.g., CPLEX solver) to determine a minimization of the objective function (e.g., a minimization of eq. 2). In some examples, a user configured weight is applied to each objective function expression. For example, a user may provide an input to category assignment computing device 102 characterizing a value (e.g., 0 to 1, inclusive) for a weight (e.g., w₁) of an object function. Category assignment computing device 102 may store the value of each weight within database 116, and may apply the weight to each corresponding objective function expression to solve the objective function. Further, category assignment computing device 102 generates assignment data assigning each category to the determined placement option, and may store the assignment data in database 116.

In some examples, category assignment computing device 102 may generate a score based on the output of the objective function. Category assignment computing device 102 may then add one or more of the above noted constraint criteria, such as selective strong connectivity constraints, and may determine another plurality of placement options for the one or more categories defined by the layout data, as described herein. Category assignment computing device 102 may then re-solve the objective function to generate an additional output based on the additional plurality of placement options, and may generate an additional score based on the additional output. As such, the objective function may be executed in iterations, where each iteration adds one or more selective constraints, and may generate a score at each iteration. Category assignment computing device 102 may select the solution corresponding to the best score (e.g., the highest score) to be the final solution.

In some examples, category assignment computing device 102 receives a request, such as from workstation 106 or one of associate computing devices 110, 112, 114, for a layout (e.g., recommended layout) of a retail location, such as store 109. In response, category assignment computing device 102 may obtain the assignment data corresponding to the retail location from database 116, and may transmit the assignment data in response (e.g., to one of workstation 106 or one of associate computing devices 110, 112, 114). The assignment data may cause the receiving device to display a layout of the retail location, which may illustrate an assignment of categories to fixtures as described herein.

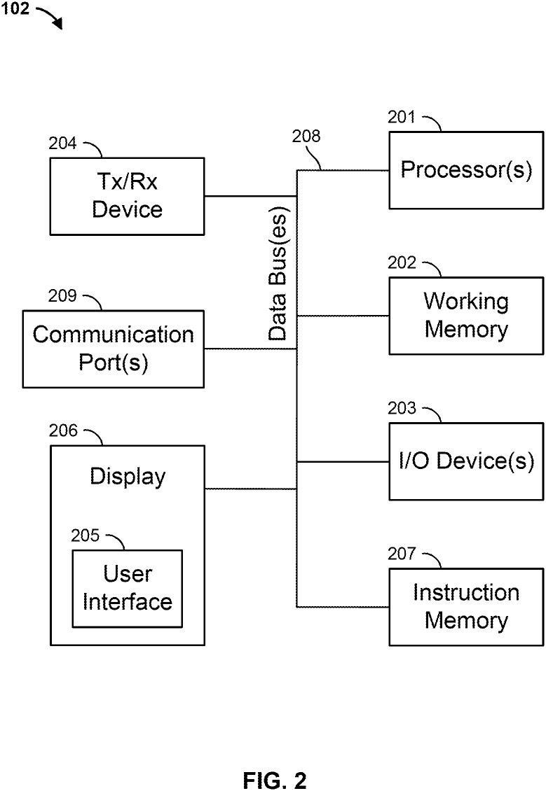

FIG. 2 illustrates an exemplary category assignment computing device 102 of FIG. 1. Category assignment computing device 102 can include one or more processors 201, working memory 202, one or more input/output devices 203, instruction memory 207, a transceiver 204, one or more communication ports 207, and a display 206, all operatively coupled to one or more data buses 208. Data buses 208 allow for communication among the various devices. Data buses 208 can include wired, or wireless, communication channels.

Processors 201 can include one or more distinct processors, each having one or more cores. Each of the distinct processors can have the same or different structure. Processors 201 can include one or more central processing units (CPUs), one or more graphics processing units (GPUs), application specific integrated circuits (ASICs), digital signal processors (DSPs), and the like.

Processors 201 can be configured to perform a certain function or operation by executing code, stored on instruction memory 207, embodying the function or operation. For example, processors 201 can be configured to perform one or more of any function, method, or operation disclosed herein.

Instruction memory 207 can store instructions that can be accessed (e.g., read) and executed by processors 201. For example, instruction memory 207 can store instructions that, when executed by one or more processors 201, cause the one or more processors 201 to perform any of the operations described herein, including generating assignment data as described herein. Instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory.

Processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of Category assignment computing device 102. Working memory 202 can be a random access memory (RAM) such as a static random access memory (SRAM) or dynamic random access memory (DRAM), or any other suitable memory.

Input-output devices 203 can include any suitable device that allows for data input or output. For example, input-output devices 203 can include one or more of a keyboard, a touchpad, a mouse, a stylus, a touchscreen, a physical button, a speaker, a microphone, or any other suitable input or output device.

Communication port(s) 209 can include, for example, a serial port such as a universal asynchronous receiver/transmitter (UART) connection, a Universal Serial Bus (USB) connection, or any other suitable communication port or connection. In some examples, communication port(s) 209 allows for the programming of executable instructions in instruction memory 207. In some examples, communication port(s) 209 allow for the transfer (e.g., uploading or downloading) of data, such as layout data.

Display 206 can display user interface 205. User interfaces 205 can enable user interaction with category assignment computing device 102. For example, user interface 205 can be a user interface for an application of a retailer that allows for the display of a retail location layout. In some examples, a user can interact with user interface 205 by engaging input-output devices 203. For example, the user may provide input to category assignment computing device 102 via user interface 205. In some examples, display 206 can be a touchscreen, where user interface 205 is displayed on the touchscreen.

Transceiver 204 allows for communication with a network, such as the communication network 118 of FIG. 1. For example, if communication network 118 of FIG. 1 is a cellular network, transceiver 204 is configured to allow communications with the cellular network. In some examples, transceiver 204 is selected based on the type of communication network 118 Category assignment computing device 102 will be operating in. Processor(s) 201 is operable to receive data from, or send data to, a network, such as communication network 118 of FIG. 1, via transceiver 204.

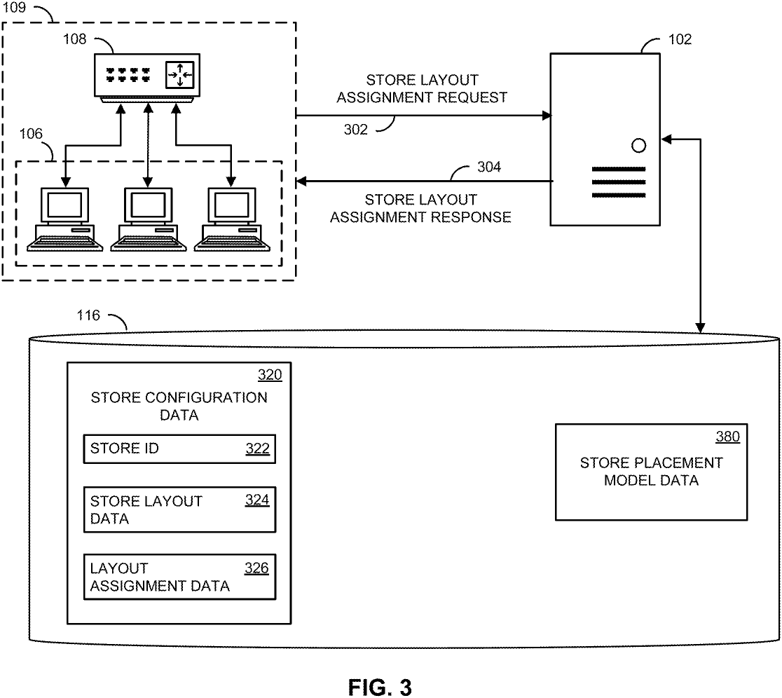

FIG. 3 is a block diagram illustrating examples of various portions of the category assignment system of FIG. 1. In this example, category assignment computing device 102 receives a store layout assignment request 302 from a store 109. The store layout assignment request 302 may include, for example, a store identification (ID) 322 identifying a retail location for which a layout assignment is being requested. Category assignment computing device 102 may extract the store ID 322 from the store layout assignment request 302, and obtain, from database 116, store layout data 324 based on the store ID 322. For example, database 116 may store configuration data 320, which may identify a store ID 322 and corresponding store layout data 324 for each of a plurality of retail locations. Based on the obtained store layout data 324, category assignment computing device 102 may perform operations to generate layout assignment data 326, which identifies and characterizes an assignment of categories to one or more fixtures (and/or fixture sections) defined by the store layout data 324.

For example, category assignment computing device 102 may obtain, from database 116, store placement model data 380, which may characterize constraint criteria and objective criteria. For example, the constraint criteria may characterize the models of equation 1, and the objective criteria may characterize the objective function of equation 2. Category assignment computing device 102 may apply the constraint criteria to the store layout data 324 to determine a plurality of placement options for each of a plurality of categories identified by the store layout data 324. Further, category assignment computing device 102 determines one of the plurality of placement options for each of the plurality of categories based on applying the objective criteria to the plurality of placement options for the plurality of categories. Category assignment computing device 102 may then generate layout assignment data 326 assigning each of the plurality of categories to the corresponding one of the plurality of categories. Category assignment computing device 102 may store the layout assignment data 326 within store configuration data 320 of database 116.

Further, category assignment computing device 102 may package the generated layout assignment data 326 within a store layout assignment response 304, and may transmit the store layout assignment response 304 to store 109 (e.g., via workstation 106). The store layout assignment response may cause workstation 106 to display a store layout for store 109 in accordance with the layout assignment data 326 received within store layout assignment response 304. In some examples, workstation 106 transmits the layout assignment data 326 to one or more of the associate computing devices 110, 112, 114, and the receiving device may display the store layout for store 109 in accordance with the layout assignment data 326 (e.g., via an application associated with displaying store layouts and configured to display the store layout based on layout assignment data 326).

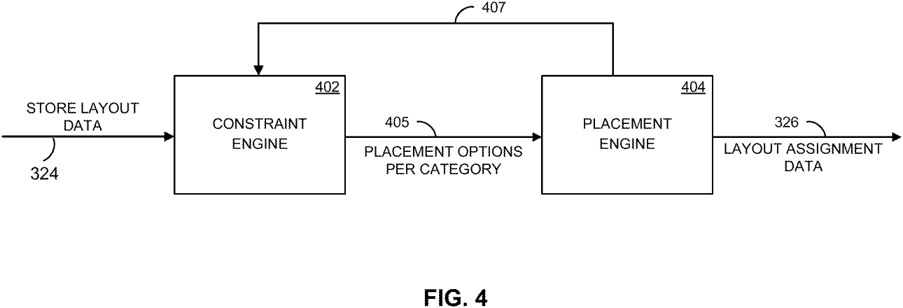

FIG. 4 illustrates exemplary portions of the category assignment computing device 102 of FIG. 1. In this example, category assignment computing device 102 includes a constraint engine 402 and a placement engine 404. In some examples, one or more of constraint engine 402 and placement engine 404 may be implemented in hardware. In some examples, one or more of constraint engine 402 and placement engine 404 may be implemented as an executable program maintained in a tangible, non-transitory memory, such as instruction memory 207 of FIG. 2, which may be executed by one or processors, such as processor 201 of FIG. 2.

In this example, constraint engine 402 obtains store layout data 324, and applies one or more models to the store layout data 324 to generate placement options per category 405. For example, constraint engine 402 may obtain constraint criteria from store placement model data 380 stored in database 116, and may execute one or more models characterized by the obtained constraint criteria (e.g., such as one or more models of equation 1). Constraint engine 402 may provide as input to the executed models at least portions of the obtained store layout data 324 to generate the placement options per category 405, which characterizes a number of placement options for each category identified by the store layout data 324.

Further, placement engine 404 receives the placement options per category 405, and applies objective criteria to the placement options per category 405 to generate layout assignment data 326. For example, placement engine 404 may obtain objective criteria from store placement model data 380 stored in database 116, and may execute a solver to solve one or more objective functions characterized by the obtained constraint criteria (e.g., such as the objective function of equation 2). Placement engine 404 may provide as input to the executed solver at least portions of the placement options per category 405 to generate the layout assignment data 326, which characterizes an assignment of one or more categories to fixtures, and/or fixture sections, defined by the store layout data 324. Placement engine 404 may store the store layout data 324 within store configuration data 320 in database 116.

In some examples, constraint engine 402 receives feedback data 407 from placement engine 404. The feedback data 407 may identify, for example, a determined assignment of one or more categories to the fixtures and/or fixture sections. Constraint engine 402 may apply one or more of the constraint criteria to the feedback data 407, to further refine placement options per category 405. Further, placement engine 404 receives the refined placement options per category 405, and applies the objective criteria to the refined placement options per category 405 to generate a refined layout assignment data 326.

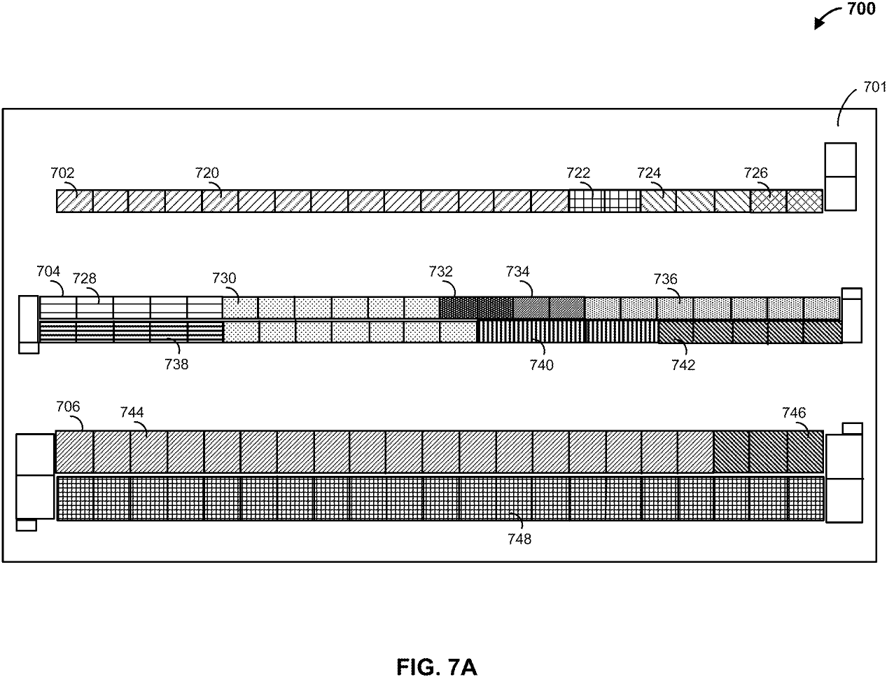

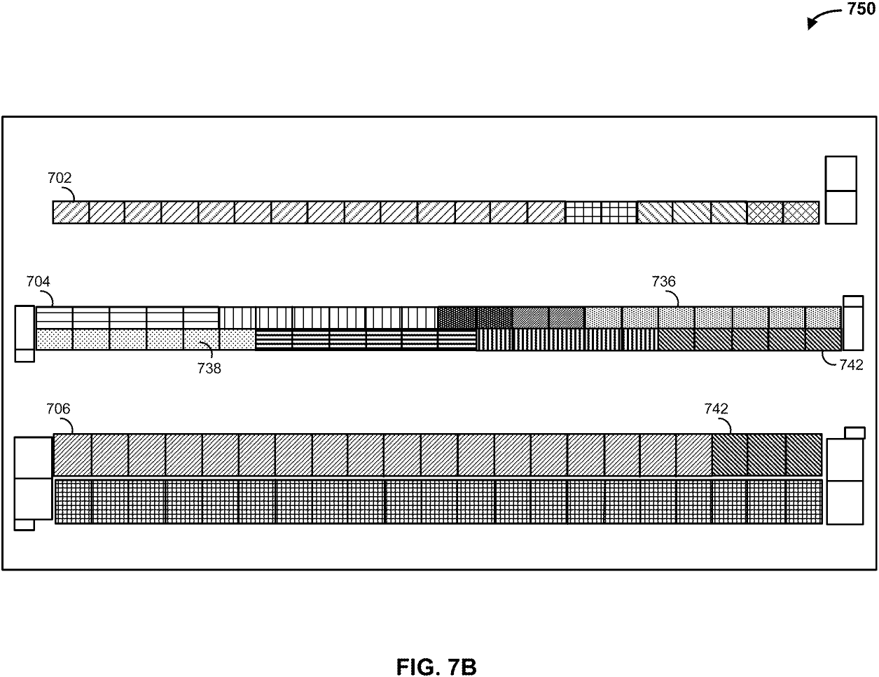

FIG. 7A illustrates an original layout 700 of a retail location 701, which may be characterized by layout data as described herein. In this example, original layout 700 includes a first fixture 702, a second fixture 704, and a third fixture 706. Original layout 700 illustrates a plurality of categories assigned to the first fixture 702, second fixture 704, and third fixture 706, as illustrated by hashed sections of each of the first fixture 702, second fixture 704, and third fixture 706. For example, each of a first category 720, second category 722, third category 724, and fourth category 726 is assigned to first fixture 702. In addition, a fifth category 728, sixth category 730, seventh category 732, eight category 734, ninth category 736, tenth category 738, eleventh category 740, and twelfth category 742 is assigned to second fixture 704. Moreover, each of a thirteenth category 744, fourteenth category 746, and fifteenth category 748 is assigned to third fixture 706.

As described herein, category assignment computing device 102 may obtain layout data characterizing original layout 700 (e.g., including graph data identifying and characterizing the fixtures as nodes and connected via edges), and applies one or more models to the layout data to generate placement options for each of the categories. For example, category assignment computing device 102 may obtain constraint criteria from store placement model data 380 stored in database 116, and may execute one or more models characterized by the obtained constraint criteria (e.g., such as one or more models of equation 1). Category assignment computing device 102 may then provide as input to the executed models at least portions of the layout data to generate the placement options for each of the categories.

Further, category assignment computing device 102 applies objective criteria to the placement options and portions of the layout data to generate layout assignment data. For example, category assignment computing device 102 may obtain objective criteria from store placement model data 380 stored in database 116, and may execute a solver to solve one or more objective functions characterized by the obtained constraint criteria (e.g., such as the objective function of equation 2). Category assignment computing device 102 may provide as input to the executed solver at least portions of the placement options and the layout data (e.g., graph data) to generate the layout assignment data, which characterizes an assignment of the one or more categories to the fixtures, and/or fixture sections, defined by the layout data.

For example, FIG. 7B illustrates an updated layout 750 of retail location 701, which may be generated and displayed based on the layout assignment data generated for FIG. 7A. Compared to original layout 700, ninth category 736 was increased by one section, while tenth category 738 was reduced by one section. Further, twelfth category 742 was increased by three sections, including a wrapping that includes three sections in third fixture 706, and removed thirteenth category 744 from third fixture 706.

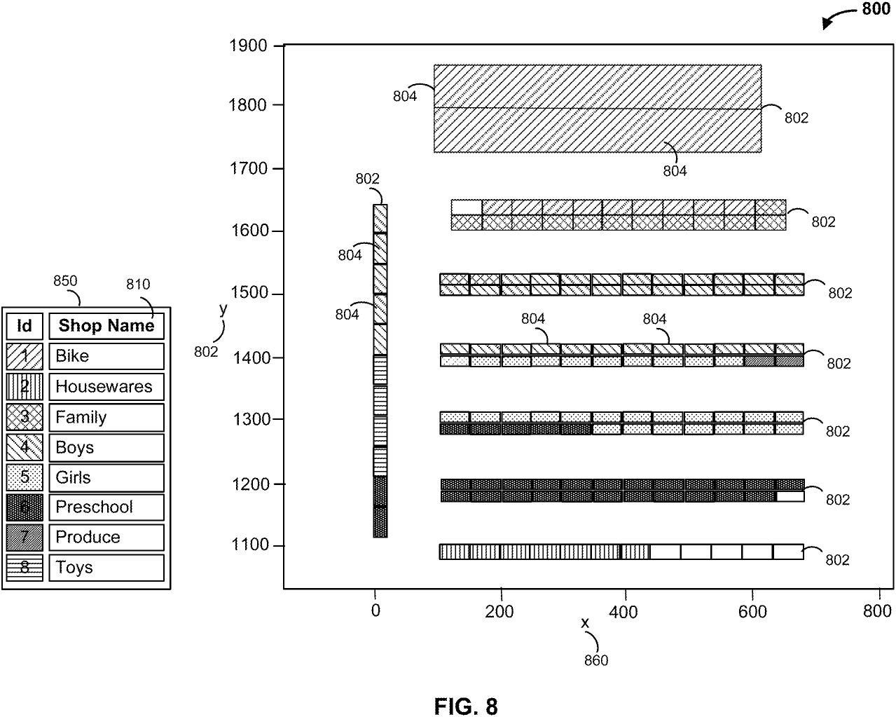

FIG. 8 illustrates a layout 800 that may be displayed based on assignment data generated by category assignment computing device 102. For example, and as described herein, category assignment computing device 102 may generate assignment data identifying and characterizing an assignment of categories to fixtures (e.g., fixture sections) of a retail location, and to shops of the retail location. Each shop may include one or more categories, for example. In some examples, category assignment computing device 102 may receive a request for the assignment data from another computing device (e.g., via a store layout assignment request 302), and in response may transmit the assignment data to the other computing device (e.g., via a store layout assignment response 304). The assignment data may cause the receiving computing device to display a layout, such as layout 800, based on the received assignment data. For example, the computing device may illustrate a plurality of fixtures 802, where a fixture 802 may include one or more fixture sections 804. In addition, the fixtures 802 may correspond to a shop 810, illustrated based on hashing. In some examples, each shop is displayed in a differing color. Moreover, layout 800 may also include a legend 850 that identifies the shops 810. Layout 800 may further include an indication of dimensions. In this example, layout 800 includes an indication of a length 860 in an “x” direction, and an indication of a width 862 in a “y” direction. The length 800 and width 862 may be measured in feet or meters, for example.

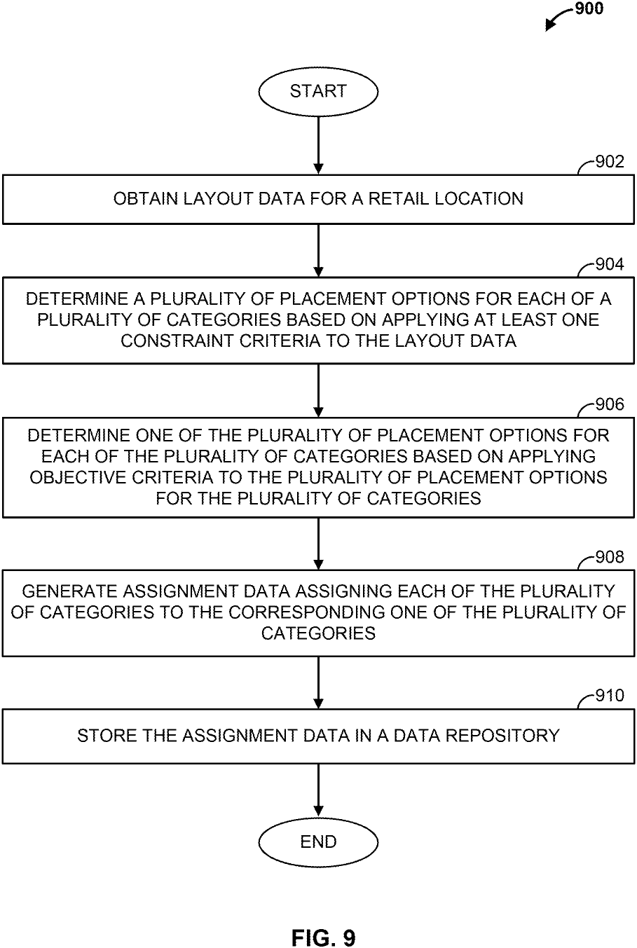

FIG. 9 is a flowchart of an example method 900 that can be carried out by the category assignment computing device 102 of FIG. 1. Beginning at step 902, category assignment computing device 102 obtains layout data for a retail location (e.g., store). The layout data may identify and characterize a location of fixtures, such as shelving, end caps, and aisles, within the retail location. At step 904, category assignment computing device 102 determines a plurality of placement options for each of a plurality of categories based on applying at least one constraint criteria to the layout data. For example, category assignment computing device 102 may obtain constraint criteria from store placement model data 380 stored in database 116, and may execute one or more models characterized by the obtained constraint criteria (e.g., such as one or more models of equation 1) to determine the plurality of placement options for each of the plurality of categories.

Proceeding to step 906, category assignment computing device 102 determines one of the plurality of placement options for each of the plurality of categories based on applying objective criteria to the plurality of placement options for the plurality of categories. For example, category assignment computing device 102 may obtain objective criteria from store placement model data 380 stored in database 116, and may execute a solver to solve one or more objective functions characterized by the obtained constraint criteria (e.g., such as the objective function of equation 2) to one of the plurality of placement options for each of the plurality of categories.

At step 908, category assignment computing device 102 generates assignment data (e.g., layout assignment data 326) assigning each of the plurality of categories to the corresponding one of the plurality of categories. Further, and at step 910, category assignment computing device 102 stores the assignment data in a data repository. For example, category assignment computing device 102 may store the store layout data 324 within store configuration data 320 of database 116. The method then ends.

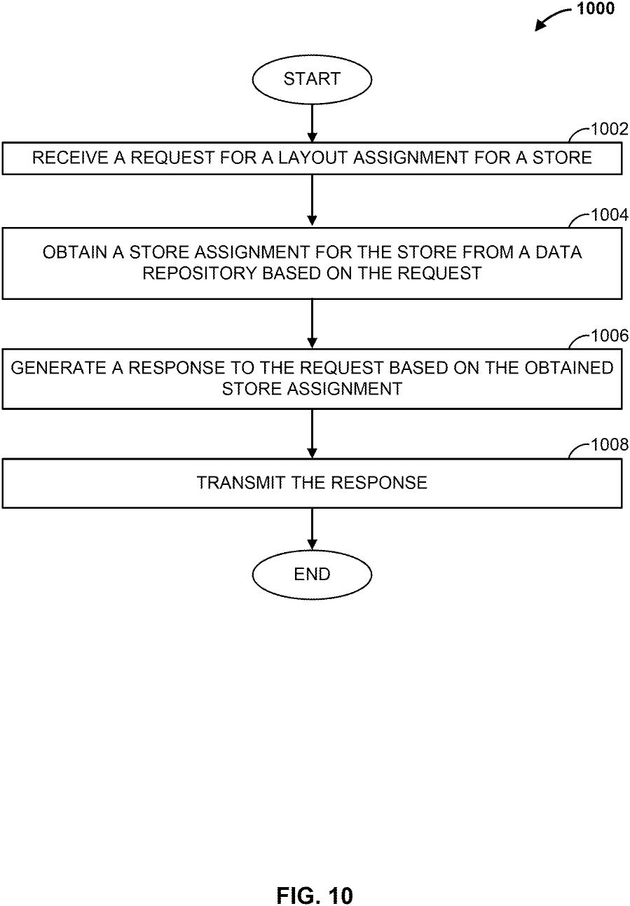

FIG. 10 is a flowchart of an example method 1000 that can be carried out by the category assignment computing device 102 of FIG. 1. Beginning at step 1002, category assignment computing device 102 receives a request for a layout assignment for a store. For example, category assignment computing device 102 may receive a store layout assignment request 302 from workstations 106 for a store 109. At step 1004, category assignment computing device 102 obtains store assignment data for the store from a data repository based on the request. For example, category assignment computing device 102 may extract a store ID 322 from the store layout assignment request 302, and based on the store ID 322, may obtain layout assignment data 326 from database 116.

Further, and at step 1006, category assignment computing device 102 may generate a response to the request that includes the obtained store assignment data. For example, category assignment computing device 102 may generate a store layout assignment response 304 that includes the obtained layout assignment data 326 for the store 109. At step 1008, category assignment computing device 102 may transmit the response. For example, category assignment computing device 102 may transmit the store layout assignment response 304 to workstation 106 of store 109. The received store assignment data may cause the receiving device to display a layout, such as layout 800. The method then ends.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The following clause listing includes exemplary embodiments.

1. A system comprising:
a computing device comprising at least one processor, where the computing device is configured to:
   obtain layout data for a retail location;
   determine a plurality of placement options for each of a plurality of categories based on applying at least one constraint criteria to the layout data;
   determine one of the plurality of placement options for each of the plurality of categories based on applying objective criteria to the plurality of placement options for the plurality of categories;
   generate assignment data assigning each of the plurality of categories to the corresponding one of the plurality of categories; and
   store the assignment data in a data repository.

2. The system of clause 1, wherein the layout data identifies a plurality of fixtures within the retail location.

3. The system of clause 2, wherein determining the plurality of placement options comprises:
assigning the plurality of categories to the plurality of fixtures for each of the plurality of placement options; and
applying the at least one constraint criteria comprises determining an adjacency relationship between the assigned plurality of categories for each of the plurality of placement options.

4. The system of any of clauses 2-3, wherein determining the plurality of placement options comprises:
assigning the plurality of categories to the plurality of fixtures for each of the plurality of placement options; and
applying the at least one constraint criteria comprises determining at least one connectivity constraint between pairs of the assigned plurality of categories for each of the plurality of placement options.

5. The system of any of clauses 2-4, wherein determining the plurality of placement options comprises assigning at least one of the plurality of categories to a same fixture of the plurality of fixtures for each of the plurality of placement options.

6. The system of any of clauses 1-5, wherein the objective criteria comprises an objective function, wherein the computing device is configured to determine the one of the plurality of placement options for each of the plurality of categories based on generating output data characterizing a minimization of the objective function.

7. The system of clauses 6, wherein the objective function comprises a plurality of expressions, and wherein the computing device is configured to apply a weight to each of the plurality of expressions.

8. The system of clause 7, wherein the plurality of expressions comprise an expression to minimize movement of the plurality of categories from a first location to a second location.

9. The system of clauses 1-8, wherein applying the objective criteria to the plurality of placement options for the plurality of categories comprises:
determining an output value for each of the plurality of placement options based on a plurality of options for each of the plurality of categories; and
determining the one of the plurality of placement options for each of the plurality of categories based on the output values.

10. The system of any of clauses 1-9, wherein the computing device is configured to:
receive a request for the assignment data for the retail location; and
transmit the assignment data in response to the request.

11. A method comprising:
obtaining layout data for a retail location;
determining a plurality of placement options for each of a plurality of categories based on applying at least one constraint criteria to the layout data;
determining one of the plurality of placement options for each of the plurality of categories based on applying objective criteria to the plurality of placement options for the plurality of categories;
generating assignment data assigning each of the plurality of categories to the corresponding one of the plurality of categories; and
storing the assignment data in a data repository.

12. The method of clause 11 wherein the layout data identifies a plurality of fixtures within the retail location.

13. The method of clause 12, wherein determining the plurality of placement options comprises:
assigning the plurality of categories to the plurality of fixtures for each of the plurality of placement options; and
applying the at least one constraint criteria comprises determining an adjacency relationship between the assigned plurality of categories for each of the plurality of placement options.

14. The method of any of clauses 12-13, wherein determining the plurality of placement options comprises:
assigning the plurality of categories to the plurality of fixtures for each of the plurality of placement options; and
applying the at least one constraint criteria comprises determining at least one connectivity constraint between pairs of the assigned plurality of categories for each of the plurality of placement options.

15. The method of any of clauses 12-14, wherein determining the plurality of placement options comprises assigning at least one of the plurality of categories to a same fixture of the plurality of fixtures for each of the plurality of placement options.

16. The method of any of clauses 11-15, wherein the objective criteria comprises an objective function, wherein the method comprises determining the one of the plurality of placement options for each of the plurality of categories based on generating output data characterizing a minimization of the objective function.

17. The method of clause 16, wherein the objective function comprises a plurality of expressions, and wherein the method comprises applying a weight to each of the plurality of expressions.

18. The method of clause 17, wherein the plurality of expressions comprise an expression to minimize movement of the plurality of categories from a first location to a second location.

19. The method of any of clauses 11-18, wherein applying the objective criteria to the plurality of placement options for the plurality of categories comprises:
determining an output value for each of the plurality of placement options based on a plurality of options for each of the plurality of categories; and
determining the one of the plurality of placement options for each of the plurality of categories based on the output values.

20. The method of any of clauses 11-19, wherein the method comprises:
receiving a request for the assignment data for the retail location; and
transmitting the assignment data in response to the request.

21. A non-transitory computer readable medium having instructions stored thereon, wherein the instructions, when executed by at least one processor, cause a device to perform operations comprising:
obtaining layout data for a retail location;
determining a plurality of placement options for each of a plurality of categories based on applying at least one constraint criteria to the layout data;
determining one of the plurality of placement options for each of the plurality of categories based on applying objective criteria to the plurality of placement options for the plurality of categories;
generating assignment data assigning each of the plurality of categories to the corresponding one of the plurality of categories; and
storing the assignment data in a data repository.

22. The non-transitory computer readable medium of clause 21, wherein the layout data identifies a plurality of fixtures within the retail location.

23. The non-transitory computer readable medium of clause 22, wherein determining the plurality of placement options comprises:
assigning the plurality of categories to the plurality of fixtures for each of the plurality of placement options; and
applying the at least one constraint criteria comprises determining an adjacency relationship between the assigned plurality of categories for each of the plurality of placement options.

24. The non-transitory computer readable medium of any of clauses 22-23, wherein determining the plurality of placement options comprises:
assigning the plurality of categories to the plurality of fixtures for each of the plurality of placement options; and
applying the at least one constraint criteria comprises determining at least one connectivity constraint between pairs of the assigned plurality of categories for each of the plurality of placement options.

25. The non-transitory computer readable medium of any of clauses 22-24, wherein determining the plurality of placement options comprises assigning at least one of the plurality of categories to a same fixture of the plurality of fixtures for each of the plurality of placement options.

26. The non-transitory computer readable medium of any of clauses 21-25, wherein the instructions, when executed by the at least one processor, cause the device to perform operations comprising:

wherein the objective criteria comprises an objective function, determining the one of the plurality of placement options for each of the plurality of categories based on generating output data characterizing a minimization of the objective function.

27. The non-transitory computer readable medium of any of clause 26, wherein the instructions, when executed by the at least one processor, cause the device to perform operations comprising:

wherein the objective function comprises a plurality of expressions, applying a weight to each of the plurality of expressions.

28. The non-transitory computer readable medium of clause 27, wherein the plurality of expressions comprise an expression to minimize movement of the plurality of categories from a first location to a second location.

29. The non-transitory computer readable medium of any of clauses 21-28, wherein applying the objective criteria to the plurality of placement options for the plurality of categories comprises:
determining an output value for each of the plurality of placement options based on a plurality of options for each of the plurality of categories; and
determining the one of the plurality of placement options for each of the plurality of categories based on the output values.

30. The non-transitory computer readable medium of any of clauses 21-29, wherein the instructions, when executed by the at least one processor, cause the device to perform operations comprising:
receiving a request for the assignment data for the retail location; and
transmitting the assignment data in response to the request.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A system comprising:
a computing device comprising at least one processor, where the computing device is configured to:
obtain layout data for a retail location;
determine a plurality of placement options for each of a plurality of categories based on applying at least one constraint criteria to the layout data;
determine one of the plurality of placement options for each of the plurality of categories based on applying objective criteria to the plurality of placement options for the plurality of categories;
generate assignment data assigning each of the plurality of categories to the corresponding one of the plurality of categories; and
store the assignment data in a data repository.

2. The system of claim 1, wherein the layout data identifies a plurality of fixtures within the retail location.

3. The system of claim 2, wherein determining the plurality of placement options comprises:
assigning the plurality of categories to the plurality of fixtures for each of the plurality of placement options; and
applying the at least one constraint criteria comprises determining an adjacency relationship between the assigned plurality of categories for each of the plurality of placement options.

4. The system of claim 2, wherein determining the plurality of placement options comprises:
assigning the plurality of categories to the plurality of fixtures for each of the plurality of placement options; and
applying the at least one constraint criteria comprises determining at least one connectivity constraint between pairs of the assigned plurality of categories for each of the plurality of placement options.

5. The system of claim 2, wherein determining the plurality of placement options comprises assigning at least one of the plurality of categories to a same fixture of the plurality of fixtures for each of the plurality of placement options.

6. The system of claim 1, wherein the objective criteria comprises an objective function, wherein the computing device is configured to determine the one of the plurality of placement options for each of the plurality of categories based on generating output data characterizing a minimization of the objective function.

7. The system of claim 6, wherein the objective function comprises a plurality of expressions, and wherein the computing device is configured to apply a weight to each of the plurality of expressions.

8. The system of claim 7, wherein the plurality of expressions comprise an expression to minimize movement of the plurality of categories from a first location to a second location.

9. The system of claim 1, wherein applying the objective criteria to the plurality of placement options for the plurality of categories comprises:
determining an output value for each of the plurality of placement options based on a plurality of options for each of the plurality of categories; and
determining the one of the plurality of placement options for each of the plurality of categories based on the output values.

10. The system of claim 1, wherein the computing device is configured to:
receive a request for the assignment data for the retail location; and
transmit the assignment data in response to the request.

11. A method comprising:
obtaining layout data for a retail location;
determining a plurality of placement options for each of a plurality of categories based on applying at least one constraint criteria to the layout data;
determining one of the plurality of placement options for each of the plurality of categories based on applying objective criteria to the plurality of placement options for the plurality of categories;
generating assignment data assigning each of the plurality of categories to the corresponding one of the plurality of categories; and
storing the assignment data in a data repository.

12. The method of claim 11 wherein the layout data identifies a plurality of fixtures within the retail location.

13. The method of claim 12 wherein determining the plurality of placement options comprises:
assigning the plurality of categories to the plurality of fixtures for each of the plurality of placement options; and
applying the at least one constraint criteria comprises determining an adjacency relationship between the assigned plurality of categories for each of the plurality of placement options.

14. The method of claim 12 wherein determining the plurality of placement options comprises:
assigning the plurality of categories to the plurality of fixtures for each of the plurality of placement options; and
applying the at least one constraint criteria comprises determining at least one connectivity constraint between pairs of the assigned plurality of categories for each of the plurality of placement options.

15. The method of claim 12 wherein determining the plurality of placement options comprises assigning at least one of the plurality of categories to a same fixture of the plurality of fixtures for each of the plurality of placement options.

16. The method of claim 11 wherein the objective criteria comprises an objective function, wherein the computing device is configured to determine the one of the plurality of placement options for each of the plurality of categories based on generating output data characterizing a minimization of the objective function.

17. The method of claim 16 wherein the objective function comprises a plurality of expressions, and wherein the computing device is configured to apply a weight to each of the plurality of expressions.

18. The method of claim 11 wherein applying the objective criteria to the plurality of placement options for the plurality of categories comprises:
determining an output value for each of the plurality of placement options based on a plurality of options for each of the plurality of categories; and
determining the one of the plurality of placement options for each of the plurality of categories based on the output values.

19. A non-transitory computer readable medium having instructions stored thereon, wherein the instructions, when executed by at least one processor, cause a device to perform operations comprising:
obtaining layout data for a retail location;
determining a plurality of placement options for each of a plurality of categories based on applying at least one constraint criteria to the layout data;
determining one of the plurality of placement options for each of the plurality of categories based on applying objective criteria to the plurality of placement options for the plurality of categories;
generating assignment data assigning each of the plurality of categories to the corresponding one of the plurality of categories; and
storing the assignment data in a data repository.

20. The non-transitory computer readable medium of claim 18, wherein the layout data identifies a plurality of fixtures within the retail location, and wherein the instructions, when executed by the at least one processor, cause the device to perform operations comprising:
assigning the plurality of categories to the plurality of fixtures for each of the plurality of placement options; and
applying the at least one constraint criteria comprises:
determining an adjacency relationship between the assigned plurality of categories for each of the plurality of placement options; and
determining at least one connectivity constraint between pairs of the assigned plurality of categories for each of the plurality of placement options.
